(19) United States
(12) Patent Application Publication
(10) Pub. No.: US 2007/0192149 A1
(43) Pub. Date: Aug. 16, 2007

(54) System and method for managing risk in services solution development

(75) Inventors: Mary Elizabeth Helander, North White Plains, NY (US); Kaan Kudsi Katircioglu, Yorktown Heights, NY (US); Giuseppe Andrea Paleologo, Bronx, NY (US); Bonnie Kathryn Ray, Nyack, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/354,192

(22) Filed: Feb. 15, 2006

(51) Int. Cl. G06F 9/44

(52) U.S. Cl. 705/7

(57) ABSTRACT

A system (and method, and method for deploying computing infrastructure) for planning for development of at least one services solution offering, includes a generating unit that generates an action plan for at least one portion of a development lifecycle of the services solution offering.

### BACKGROUND OF THE INVENTION

1. Field of the Invention

The present invention generally relates to a system and method for managing risk within the process of developing a services solution offering. More particularly, the present invention relates to a system, method, and framework for simultaneously planning for the development of an action plan for one or more service offerings, and even more particularly, of an action plan that can be incremental, incorporate risk and uncertainty, etc., as well as proactively plan for postponement (e.g., intentional delays), acceleration, deceleration, starting, stopping, selling, licensing, etc., within a development lifecycle of a services offering solution.

2. Description of the Related Art

There are no known solutions to this problem, although there are conventional approaches proposed in other domains such as (a) the use of real options for investing under uncertainty in technology development, and oil/gas exploration and (b) the concept of postponement used in supply chain execution.

The conventional methods have contemplated postponement in a supply chain, for example, of a product manufacturing process or product distribution process. By postponing elements of the supply chain, the manufacturer can better react to uncertainty.

The risk is that the manufacturer may produce too much of a product, which results in lost profits and inventory being unsold. Alternatively, the manufacturer may produce too little of a product, which can result in lost profits.

Postponement in a supply chain means that a manufacturer or supplier intentionally delays the movement of a component of a product or goods, or the finished product or goods, at any stage in the manufacturing process, or distribution process of the product or goods.

By intentionally delaying or postponing elements of the supply chain in a manufacturing or distribution process, certain states, such as demand, become more certain.

If the manufacturer can postpone or delay the movement of goods or the distribution of components of a product, the manufacturer can react to better information concerning demand, etc. and can better optimize profitability, avoid lost profits, etc.

Generally, the conventional planning frameworks or methods exist where usage is uncertain.

The conventional methods have focused on where and how to postpone in the supply chain, for example, of a manufacturing or distribution process. However, the conventional methods have not dealt with or addressed the unique problems associated with the development of services solutions.

Applicants have recognized that a solution with respect to services solution development is needed since planning for services offerings involves the development of a fundamentally different entity than planning for manufacturing and/or distribution of goods and products.

### SUMMARY OF THE INVENTION

In view of the foregoing and other exemplary problems, drawbacks, and disadvantages of the related art methods and structures, an exemplary feature of the present invention is to provide a system, method, and framework for simultaneously planning for the development of an action plan for one or more service offerings, and even more particularly, of an action plan that can be incremental, incorporate risk and uncertainty, etc., as well as proactively plan for postponement (e.g., intentional delays), acceleration, deceleration, starting, stopping, selling, licensing, etc., within a development lifecycle of a services offering solution. The present inventors have recognized that the conventional methods of postponement do not relate to optimizing within the development of services solution offerings. The present inventors also have recognized that conventional concepts of solution portfolio management generally focus on what to have/not have, and how to budget across a portfolio.

However, the conventional methods and systems do not contemplate managing/planning the development of service solution offerings by developing an action plan for intentionally delaying, accelerating, decelerating, starting, stopping, selling, licensing, etc., at some lifecycle stage of the development.

The present invention provides a method and framework which can characterize various aspects of uncertainty about usage and demand for a services solution. The present invention can incorporate this uncertainty into a planning method that uses mathematics to determine the optimal strategy for postponement of the development, etc.

For purposes of this disclosure, the term “services solution” generally means a “package” that can be sold to a customer (e.g., a business or residential services customer, a business or residential utility customer, etc.).

For example, a “package” can include: a technical concept, such as pure consulting, software, hardware, templates and data assets that implement the solution for the concept, an engagement project plan that defines the end-to-end set of activities for deployment of the solution to a given business customer, etc.

In one exemplary aspect of the invention, a method (e.g., a computer-implemented method) of planning for development of at least one services solution offering includes generating an action plan (e.g., an incremental action plan) for at least one element of a development lifecycle of the services solution offering.

In another exemplary aspect of the invention, a system for planning for development of at least one services solution offering includes a generating unit that generates an action plan (e.g., an incremental action plan) for at least one element of a development lifecycle of the services solution offering.

In yet another exemplary aspect of the invention, a system for planning for development of at least one services solution offering includes means for generating an action plan (e.g., an incremental action plan) for at least one element of a development lifecycle of the services solution offering, wherein the means for generating includes means for determining a point in time to at least one of delay, accelerate, decelerate, restart, stop, sell, license, downsize, upsize, outsource, change sourcing, alter a nature of deliverables, and retool the at least one element of the development lifecycle of the services solution offering

In yet another exemplary aspect of the invention, a method of deploying computing infrastructure in which recordable, computer-readable code is integrated into a computing system, and combines with the computing system to perform a method of planning for development of at least one services solution offering, includes generating an action plan for at least one element of a development lifecycle of the services solution offering.

In still another exemplary aspect of the invention, a signal-bearing medium tangibly embodying a program of recordable, machine-readable instructions executable by a digital processing apparatus to perform a method of planning for development of at least one services solution offering, includes generating an action plan for at least one element of a development lifecycle of the services solution offering.

The action plan generated according to the present invention can include, for example, postponement, or intentionally delaying, of one or more elements of a development lifecycle of the services solution offering, for example, until more relevant information (e.g., decision making criteria) becomes available. For purposes of this disclosure, with respect to services solution offerings, the term “postponement” generally means the intentional delay of progress in the services solution offering's development lifecycle process.

The present invention is not limited, however, to postponement of elements of the development lifecycle. The action plan according to the present invention also can include, for example, accelerating, decelerating, restarting, stopping, selling, and/or licensing, etc., one or more elements of a development lifecycle of the services solution offering.

The ordinarily skilled artisan also would understand that the action plan according to the present invention can include other exemplary actions such as downsizing or upsizing (e.g., the scope of the stage of development), outsourcing or changing sourcing, altering the nature of deliverables, and/or retooling (e.g., changing the resources), etc., of one or more elements of a development lifecycle of the services solution offering.

The action plan according to the present invention can be generated based on, for example, one or more decision-making criteria, such as risk, uncertainty, expected/predicted cost, expected/predicted revenue, expected/predicted profit, probability of meeting budget, probability of meeting revenue target, and/or probability of meeting profit target, etc.

The ordinarily skilled artisan would understand that each of the decision-making criteria, such as risk and uncertainty, can be based on, for example, one or more metrics, such as standard deviation of cost, standard deviation of revenue, standard deviation of profit, value at risk measures, and/or an uncertainty of predetermined forecasted information with respect to the services solution offering, etc. The forecasted information can include, for example, a business value, a business benefit, and/or a cost or value of at least one alternative to the services solution offering, etc.

While the invention has been described in terms of several exemplary embodiments, those skilled in the art will recognize that the invention can be practiced with modification within the spirit and scope of the appended claims, and that other exemplary actions, decision-making criteria, and metrics can be employed according to the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a flow diagram of a method 100 according to an exemplary, non-limiting embodiment of the present invention;

FIG. 2 illustrates a flow diagram of a method 200 according to another exemplary, non-limiting embodiment of the present invention;

FIG. 3 illustrates a system 300 according to an exemplary aspect of the invention;

FIG. 4 illustrates a portfolio of services solution offerings according to an exemplary aspect of the invention;

FIG. 5 illustrates an exemplary table showing costs, value, and accuracy over time according to an exemplary aspect of the invention;

FIG. 6 illustrates a chart plotting risk levels, according to an exemplary aspect of the invention;

FIG. 7 illustrates an exemplary product development support scheme, according to an exemplary aspect of the invention;

FIG. 8 illustrates an exemplary product development support scheme, according to another exemplary aspect of the invention;

FIG. 9 illustrates an exemplary hardware/information handling system 900 for incorporating the present invention therein; and

FIG. 10 illustrates a signal bearing medium (e.g., storage medium 1000) for storing/recording steps of a program of a method according to the present invention.

### DETAILED DESCRIPTION OF EXEMPLARY EMBODIMENTS OF THE INVENTION

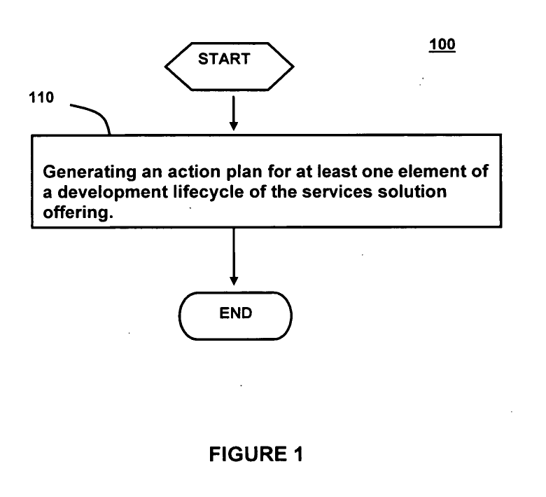

Referring now to the drawings, and more particularly to FIGS. 1-10, there are shown exemplary embodiments of the method and structures according to the present invention.

The present invention generally relates to a system and method for managing risk within the process of developing a services solution offering. There are no known solutions to this problem, although there are approaches proposed in other domains such as (a) the use of real options for investing under uncertainty in technology development, and oil/gas exploration and (b) the concept of postponement used in supply chain execution. The present invention has recognized that a novel solution is needed for services solution offerings because planning for services offerings involves the development of a fundamentally different entity than the conventional supply chain scenario.

To solve the above problems, the present invention provides a novel system, method, and framework for simultaneously planning for the development of an action plan for one or more service offerings. An important aspect of the invention is that the method and system of the present invention can proactively plan for actions within the development lifecycle of a services solution offering. The action plan can be incremental and can incorporate, for example, risk and/or uncertainty, etc., as well as proactively plan for postponement (e.g., intentional delays), acceleration, deceleration, starting, stopping, etc., within a development lifecycle of a services offering solution. With reference to FIG. 1, the exemplary aspects of the invention provide a method 100 of planning for development of at least one services solution offering. The method 100 includes generating (e.g., 110) an action plan (e.g., an incremental action plan) for at least one element of a development lifecycle of the services solution offering.

The action plan according to the present invention can include, for example, postponing, accelerating, decelerating, restarting, stopping, selling, and/or licensing, etc., one or more elements of a development lifecycle of the services solution offering.

The action plan according to the present invention cain include other exemplary actions such as downsizing or upsizing (e.g., the scope of the stage of development), outsourcing or changing sourcing, altering the nature of deliverables, and/or retooling (e.g., changing the resources), etc. of one or more elements of a development lifecycle of the services solution offering.

The action plan according to the present invention can be generated based on, for example, one or more decision-making criteria, such as risk, uncertainty, expected/predicted cost, expected/predicted revenue, expected/predicted profit, probability of meeting budget, probability of meeting revenue target, and/or probability of meeting profit target, etc.

The ordinarily skilled artisan would understand that each of the decision-making criteria, such as risk and uncertainty, can be based on, for example, one or more metrics, such as standard deviation of cost, standard deviation of revenue, standard deviation of profit, value at risk measures, and/or an uncertainty of predetermined forecasted information with respect to the services solution offering, etc. The forecasted information can include, for example, a business value, a business benefit, and/or a cost or value of at least one alternative to the services solution offering, etc.

It is noted that, while the invention has been described in terms of several exemplary embodiments, those skilled in the art will recognize that the invention can be practiced with modification within the spirit and scope of the appended claims, and that other exemplary actions, decision-making criteria, and metrics can be employed according to the present invention.

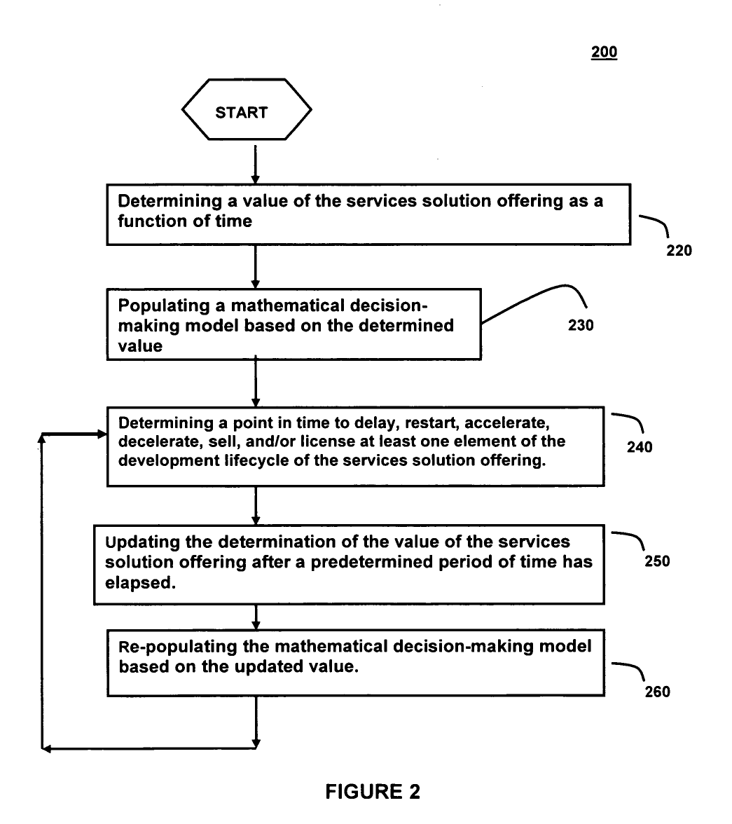

With reference to FIG. 2, an exemplary method 200 of generating (e.g., 110) an action plan (e.g., incremental action plan) can include, for example, determining (e.g., 220) a value of the services solution offering as a function of time, populating (e.g., 230) a mathematical decision-making model based on the determined value, and determining (e.g., 240) a point in time to delay, restart, accelerate, decelerate, sell, and/or license at least one element of the development lifecycle of the services solution offering.

The exemplary method 200 of generating (e.g., 110) an incremental action plan can include, for example, updating (e.g., 250) the determination of the value of the services solution offering after a predetermined period of time has elapsed, and re-populating (e.g., 260) the mathematical decision-making model based on the updated value, and then determining (e.g., 240) another point in time to postpone, restart, accelerate, decelerate, stop, sell, and/or license, etc., at least one element of the development lifecycle of the services solution offering.

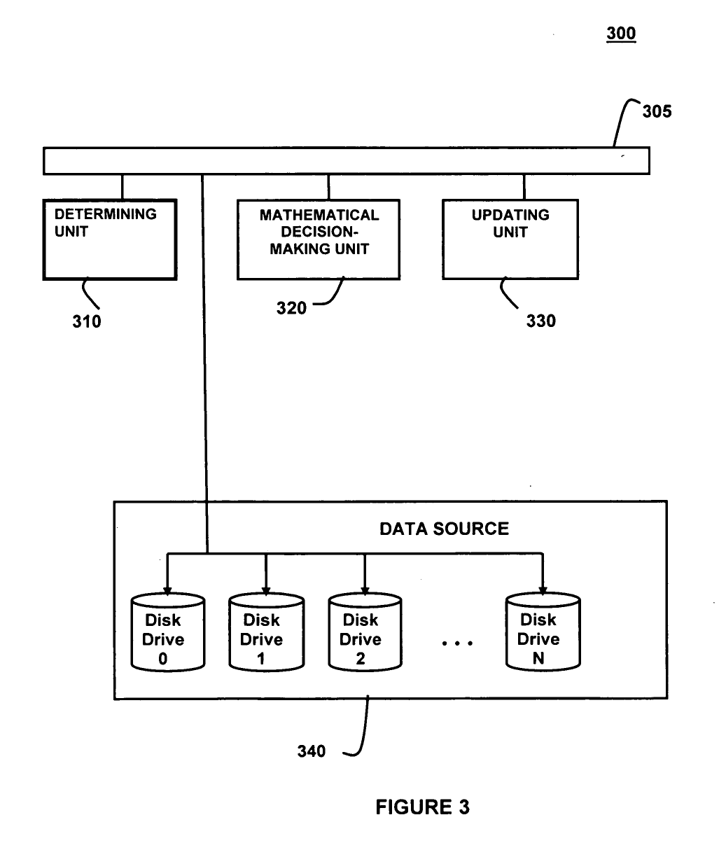

FIG. 3 illustrates an exemplary system for planning for development of at least one services solution offering, according to the present invention. The system includes a generating unit 300 that generates an action plan (e.g., an incremental action plan) for at least one element of a development lifecycle of the services solution offering.

The exemplary generating unit 300 can include, for example, a determining unit 310 that determines a value of the services solution offering as a function of time, a mathematical decision-making unit 320 that receives as input the determined value and determines a point in time to at least one of delay/postpone, restart, accelerate, decelerate, stop, sell, and/or license, etc., at least one element of the development lifecycle of the services solution offering.

The exemplary generating unit 300 can include, for example, an updating unit 330 that updates the value of the services solution offering after a predetermined period of time has elapsed.

In another exemplary aspect, the system can include a first determining unit that determines at least one alternative development path of the services solution offering, an identifying unit that identifies at least one activity or action within each alternative development path, a calculating unit that calculates a development cost of each alternative development path and activity, a second determining unit that determines a value generated by each activity, and a third determining unit that determines a best development path based on, for example, at least one of the development cost and the generated value.

The development path can be determined based on, for example, one or more decision-making criteria, such as risk, uncertainty, expected/predicted cost, expected/predicted revenue, expected/predicted profit, probability of meeting budget, probability of meeting revenue target, and/or probability of meeting profit target, etc. The ordinarily skilled artisan would understand that each of the decision-making criteria, such as risk, can be based on, for example, one or more metrics, such as standard deviation of cost, standard deviation of revenue, standard deviation of profit, and/or value at risk measures, etc.

As illustrated in FIG. 3, metrics for the services solution offering can be stored in and/or retrieved from, for example, a data source 340, or entered by a user using a graphical user interface (GUI).

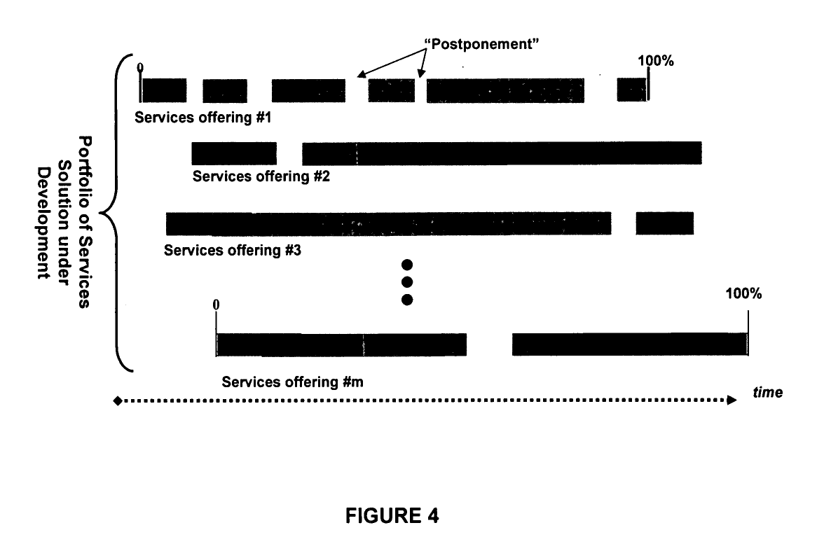

The present invention provides a novel method for postponement that can effectively be used to provide optimization both within the individual lifecycle of a services solution development, as well as across a portfolio of services solutions which are under development, as exemplarily illustrated in FIG. 4.

For example, the present invention has recognized that, in developing a services solution offering for consulting and system integration of a new software application module, a consulting services company may need to know how much effort and to what stage to develop the new module.

As another example, a corporate research division which has developed a new concept can benefit from a determination of the best postponement strategy for a solution development given a limited set of programmers and considerations of at least twenty (20) other solutions being developed in the pipeline.

As yet another example, the present invention has recognized that a benefit can be obtained from considering a portfolio of services solution offerings based on non-homogenous attributes and at various stages of development maturity.

According to an exemplary aspect of the invention, a set of solution offerings under development (or proposed) can be identified and called a “portfolio.”

As exemplarily illustrated in FIG. 4, according to the present invention, the portfolio can be dynamic. The portfolio can include all services solutions under consideration for development, or in some stage of development.

The elements can be at any maturity level characterized from 0-100% completion.

For example, 0% can mean “not started yet”, “un-started”, or “proposed”. On the other hand, 100% can mean “fully completed.”

Elements that are >0% or less than 100% completed can be characterized in terms of development packets, which characterize the partial nature of the solution offering and may be used to map to value.

For example, according to an exemplary aspect of the present invention, services offerings can be divided into development “packets”, which can correspond to development maturity of the services offering.

It is noted that, for purposes of this invention, development maturity is not limited to the percentage of a task that has been completed. Instead, the development maturity can include, for example, the percentage of the value of the services solution offering.

For example, the tasks associated with the development of a services solution offering can be 40% complete. However, in some exemplary instances, the value of these tasks may be quantified as 90% of the value of the development. Thus, completing the remaining 60% of the tasks may yield only an increase of 10% of the value of the development. In such cases, the exemplary method can determine whether the services solution offering should be, for example, delayed/postponed, restarted, accelerated, decelerated, stopped, sold, and/or licensed, etc.

As mentioned above, the present invention has recognized that partially developed solutions (incomplete packet sets) can have quantifiable, inherent value. Such partially developed solutions can be, for example, “sold” or “licensed” as a services solution offering to a customer, or can be “acquired” by a competitor who is interested in completing the solution.

According to the present invention, investment costs can be deterministic and can be broken down by offering, packet, and time, etc. Uncertainty in other planning data also can be modeled mathematically, as well as future demand for the service offering, market value of the service offering, etc. The ordinarily skilled artisan would understand that determining the decision-making criteria (e.g., risk, uncertainty, etc.) can be based on other exemplary metrics, as mentioned above.

The present invention also recognizes that development of a services solution may be stopped, intentionally delayed/postponed, and/or decelerated, etc., for example, to wait for better information, to avoid unnecessary costs, and/or to optimize allocation of limited resources, etc.

As mentioned above, the present invention can consider,risk and uncertainty (e.g., future demand, market value, etc.) and can use information obtained throughout the development lifecycle of the services solution offering.

According to the present invention, information can be updated and/or improved over time. That is, an important aspect of the present invention is providing decision making over time, with improved information.

As mentioned above, the method and system according to the present invention can provide a planning framework that is useful when developing one or more services offerings. The present invention recognizes that partially developed services offerings have “value”.

According to the present invention, “value” can be dynamic and can be characterized, for example, by either what a customer would be willing to pay for the partially developed services offering, or what another company would be willing to pay to acquire the intellectual property concerning the partial offering, including some combination of these.

Within the services solution development process, an important aspect of the exemplary action plan is to help manage limited resources while maximizing some exemplary performance metrics, such as future sales, revenue or profits, etc.

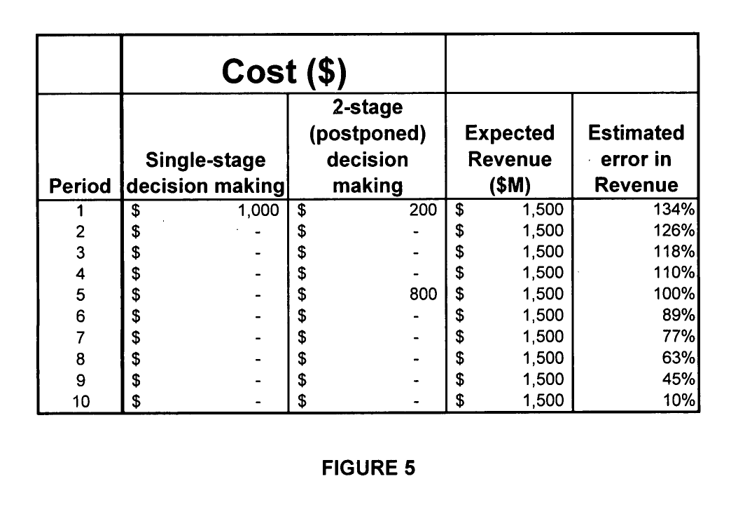

As illustrated in FIG. 5, according to the present invention, “investment costs” can be dynamic, and can be related to the effort required to complete the offering to 100%.

Uncertainty regarding other parameters can be modeled mathematically and used in the planning process. These other parameters can include, for example, future demand, market value at time of completion, etc.

The present invention provides a framework for organizing the decisions and input parameters, as well as the dynamics of the information gathering process and incremental decision making.

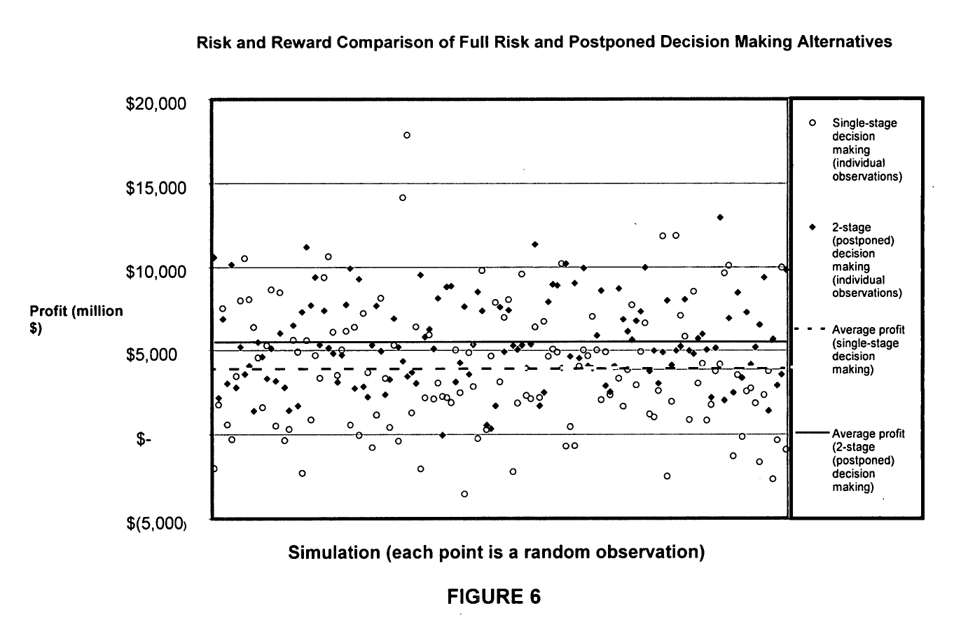

An Example 1 will be described below with reference to FIGS. 5 and 6.

### EXAMPLE 1

Let us assume there are five (5) alternative service offerings that can be developed. Let the development cost of each alternative be $1000 million (can also be uncertain in general). The revenue projection for each alternative is uncertain. There are 10 periods (e.g., months) before the development can be completed and offerings start generating revenue. Therefore, revenue should be projected well in advance. On the other hand, later in the development, there will be chances to update revenue projections, and updated projections will typically have more accuracy.
Because initial revenue projections can be very inaccurate, there is a lot of risk taking in choosing which alternative service offering to develop. The present invention can consider a simple postponement scenario where development of each alternative can be pursued until period 5 at a total development cost of $200 million each. Then, in period 5, new revenue projections can be considered to decide whether it is desirable to continue with the rest of the development. Typically, if risk adjusted revenue expectation is not higher than the remaining development cost, the development can be stopped and the partially developed solution can be used at face value.
FIG. 1 shows two approaches to decision making:
   1. Single-stage decision making: Develop each service offering fully based on initial revenue projections. Each alternative costs $1000 million to develop. Total cost is $5000 million.
   2. Two-stage postponed decision making: Develop each service offering until period 5 spending $200 million for each. Then, based on updated revenue projections, decide which offering should be developed to completion. It takes another $800 million to complete the development for each offering. Total cost depends on how many alternatives will remain after period 5.
FIG. 1 also shows the revenue forecasts and their accuracy. As time progresses, the accuracy improves.
FIG. 6 shows a scatter plot of the results of a simulation which was conducted according to the present invention in order to compare the two alternatives. Solid and dashed lines show average profits for single-stage and 2-stage decision making. It is clear that in this example, postponement of decision making works better due to its flexibility to incorporate updated revenue forecasts and change course.

### EXAMPLE 2

The exemplary method according to the present invention can formalize decisions into a mathematical model:

Vᵢⱼ=random value of project i in period j

cᵢ=Cost of project i

b=investor budget

xᵢⱼ=investment in project i in period j

yᵢⱼ=0/1, equal to one when project i is completed in period j

M=maxᵢ {b−cᵢ}

Max E ΣᵢⱼyᵢⱼVᵢⱼ
s.t. Σᵢⱼxᵢⱼ≦b
   Myᵢⱼ≧Σk<ⱼxᵢₖ−cᵢ−MΣ_{k<j}yᵢₖ
   Σᵢyᵢⱼ=1
   xᵢⱼ≧0
   yᵢⱼ=0or 1

The exemplary aspects of the present invention can provide a framework for organizing the decisions and input parameters, as well as the dynamics of the information gathering process and incremental decision making, and thus, can be effective for internal or external use by a company or entity.

For example, the exemplary method and system can be used within a company, corporation, or other business entity to enable cost effective services solution offering development in cases in which eventual demand is uncertain, in which eventual deployment characteristics are uncertain, etc.

The exemplary method and system also can provide solution development profit maximization by planning for a broader customer base, without extensive customization or reworking.

The exemplary method and system also can provide a framework for management of resource allocation over solution portfolios, during the entire lifecycle of development.

The exemplary method and system also can be applicable within the emerging concept of “services solution engineering”.

On the other hand, the exemplary method and system can be used externally from a company, corporation, or other business entity. Such external applications include, for example, product development support products sold as a solution offering to external clients (helping to target new customers who also sell services), thereby making the product development support more attractive to customers who develop services solutions.

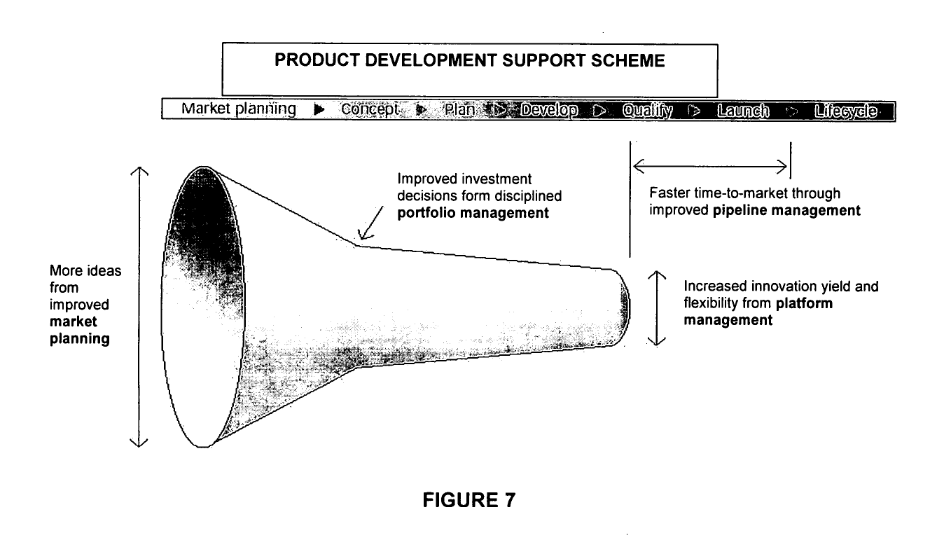

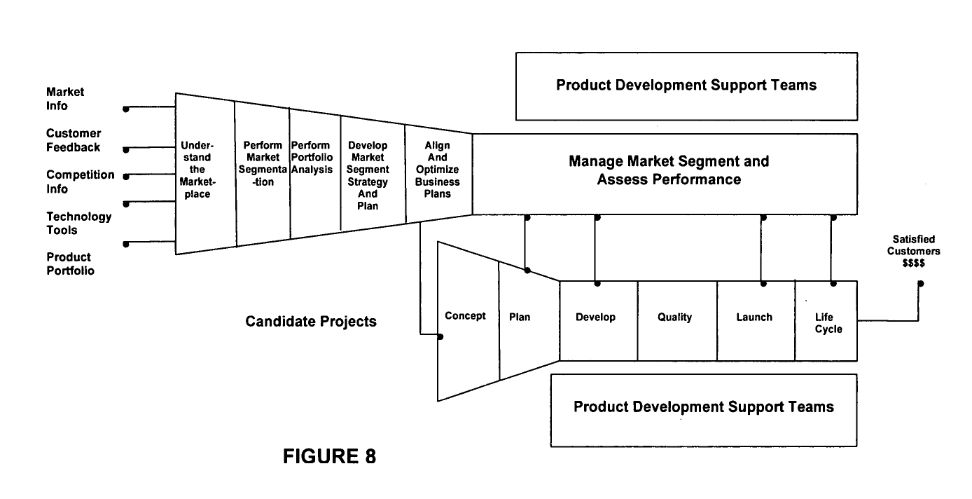

The exemplary aspects of the present invention also can be provided in one or more product development support products. FIG. 7 illustrates an exemplary product development support scheme, according to an exemplary aspect of the invention. FIG. 8 illustrates an exemplary product development support scheme, according to another exemplary aspect of the invention.

While the invention is exemplarily described with respect to these exemplary services, those skilled in the art will recognize that the invention is not limited to the exemplary embodiments and can be applied to address any type of business relationship.

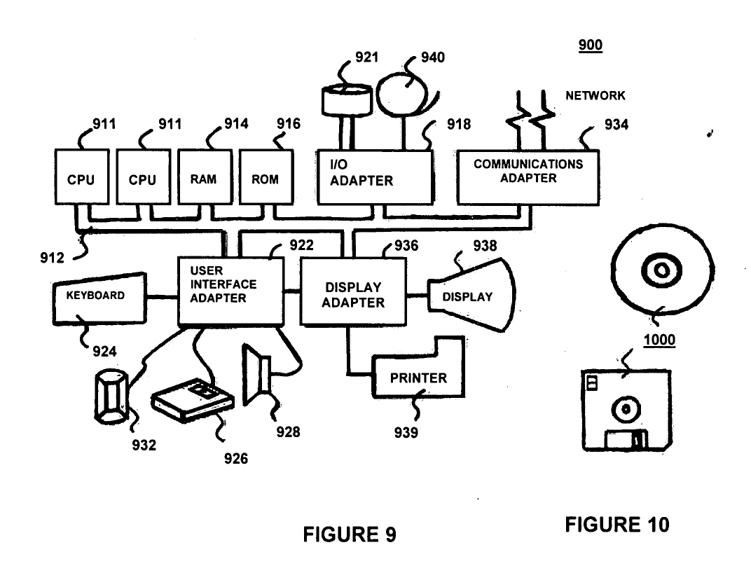

FIG. 9 illustrates an exemplary hardware/information handling system 900 for incorporating the present invention therein, and FIG. 10 illustrates a signal bearing medium 1000 (e.g., storage medium) for storing steps of a program of a method according to the present invention.

FIG. 9 illustrates a typical hardware configuration of an information handling/computer system for use with the invention and which preferably has at least one processor or central processing unit (CPU) 911.

The CPUs 911 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 939.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 911, as represented by the fast-access storage for example. Alternatively, the instructions may be contained in another signal-bearing media, such as a data storage disk/diskette 1000 (FIG. 10), directly or indirectly accessible by the CPU 911.

Whether contained in the disk/diskette 1000, the computer/CPU 911, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method of planning for development of at least one services solution offering, the method comprising:
generating an action plan for at least one portion of a development lifecycle of the services solution offering.

2. The method according to claim 1, further comprising:
executing the action plan for said at least one portion of the development lifecycle of the services solution offering.

3. The method according to claim 1, wherein said at least one portion comprises:
at least one stage of development maturity,
wherein said development maturity includes at least one of a completed development lifecycle, a partially-completed development lifecycle, and an un-started or proposed development lifecycle.

4. The method according to claim 1, wherein said action plan includes at least one of:
delaying, accelerating, decelerating, restarting, stopping, selling, licensing, downsizing, upsizing, outsourcing, changing sourcing, altering a nature of deliverables, and retooling said at least one portion of the development lifecycle of the services solution offering.

5. The method according to claim 1, wherein said action plan includes:
an incremental action plan.

6. The method according to claim 1, wherein said action plan is generated based on at least one of:
risk, uncertainty, expected/predicted cost, expected/predicted revenue, expected/predicted profit, probability of meeting a budget, probability of meeting a revenue target, and probability of meeting a profit target.

7. The method according to claim 1, wherein said generating comprises:
determining a value of said services solution offering as a function of time;
populating a mathematical decision-making model based on said determined value; and
determining a point in time to at least one of:
delay, accelerate, decelerate, restart, stop, sell, license, downsize, upsize, outsource, change sourcing, alter a nature of deliverables, and retool said at least one portion of the development lifecycle of the services solution offering.

8. The method according to claim 7, wherein said generating further comprises:
updating said determination of the value of the services solution offering after a predetermined period of time has elapsed;
re-populating said mathematical decision-making model based on said updated value; and
determining another point in time to at least one of:
delay, accelerate, decelerate, restart, stop, sell, license, downsize, upsize, outsource, change sourcing, alter a nature of deliverables, and retool said at least one portion of the development lifecycle of the services solution offering.

9. The method according to claim 1, wherein said generating comprises:
determining at least one alternative development path of said services solution offering;
identifying at least one activity within each alternative development path;
calculating a development cost of each alternative development path and activity;
determining a value generated by each activity; and
determining a best development path based on at least one of said development cost and said generated value.

10. The method according to claim 9, wherein said best development path includes at least one of:
delaying, accelerating, decelerating, restarting, stopping, selling, licensing, downsizing, upsizing, outsourcing, changing sourcing, altering a nature of deliverables, and retooling the at least one portion of the development lifecycle of the services solution offering.

11. A system for planning for development of at least one services solution offering, the system comprising:
a generating unit that generates an action plan for at least one portion of a development lifecycle of the services solution offering.

12. The system according to claim 11, wherein said portion comprises at least one of:
a completed development lifecycle, a partially completed development lifecycle, and an un-started or proposed development lifecycle, and
wherein said action plan includes at least one of:
delaying, accelerating, decelerating, restarting, stopping, selling, licensing, downsizing, upsizing, outsourcing, changing sourcing, altering a nature of deliverables, and retooling said portion of the development lifecycle of the services solution offering.

13. The system according to claim 11, wherein said generating unit generates said action plan based on at least one of:
risk, uncertainty, expected/predicted cost, expected/predicted revenue, expected/predicted profit, probability of meeting a budget, probability of meeting a revenue target, and probability of meeting a profit target.

14. The system according to claim 11, wherein said generating unit comprises:
a first determining unit that determines a value of said services solution offering as a function of time; and
a mathematical decision-making unit that receives as input the determined value and determines a point in time to at least one of:
delay, accelerate, decelerate, restart, stop, sell, license, downsize, upsize, outsource, change sourcing, alter a nature of deliverables, and retool said at least one portion of the development lifecycle of the services solution offering.

15. The system according to claim 11, wherein said generating unit comprises:
an updating unit that updates the value of the services solution offering after a predetermined period of time has elapsed.

16. The system according to claim 11, wherein said generating unit comprises:
a first determining unit that determines at least one alternative development path of said services solution offering;
an identifying unit that identifies at least one activity within each alternative development path;
a calculating unit that calculates a development cost of each alternative development path and activity;
a second determining unit that determines a value generated by each activity; and
a third determining unit that determines a best development path based on at least one of said development cost and said generated value.

17. The method according to claim 16, wherein said best development path includes at least one of:
delaying, accelerating, decelerating, restarting, stopping, selling, licensing, downsizing, upsizing, outsourcing, changing sourcing, altering a nature of deliverables, and retooling the at least one portion of the development lifecycle of the services solution offering.

18. A system for planning for development of at least one services solution offering, the system comprising:
means for generating an action plan for at least one portion of a development lifecycle of the services solution offering,
wherein said means for generating includes means for determining a point in time to at least one of:
delay, accelerate, decelerate, restart, stop, sell, license, downsize, upsize, outsource, change sourcing, alter a nature of deliverables, and retool said at least one portion of the development lifecycle of the services solution offering.

19. A method of deploying computing infrastructure in which recordable, computer-readable code is integrated into a computing system, and combines with said computing system to perform the method according to claim 1.

20. A signal-bearing medium tangibly embodying a program of recordable, machine-readable instructions executable by a digital processing apparatus to perform the method according to claim 1.
